(19) United States
(12) Patent Application Publication
(10) Pub. No.: US 2005/0242550 A1
(43) Pub. Date: Nov. 3, 2005

(54) Automotive roof system with protective device

(76) Inventor: Arthur L. MacNee, Southgate, MI (US)

Correspondence Address: HARNESS, DICKEY & PIERCE, P.L.C., P.O. BOX 828, BLOOMFIELD HILLS, MI, 48303, US

(21) Appl. No.: 10/836,821

(22) Filed: Apr. 30, 2004

(51) Int. Cl. B60R 21/22

(52) U.S. Cl. 280/730.2

(57) ABSTRACT

An automobile displaceable roof includes opposed roof support members, each including at least one side rail. Automatically inflatable airbags connect to the side rails. A sensor triggers airbag deployment. Sensor wiring is disconnectable for roof removal. Pliable, hard and sliding roof designs are provided with airbags.

### BACKGROUND AND SUMMARY OF THE INVENTION

The present invention relates generally to automotive roofs for automotive vehicles and more specifically to a device and method to attach air bags to a retractable vehicle roof structure.

Protective deployment devices, hereinafter referred to as “airbags”, are provided on modern automotive vehicles to protect the occupants during accidents or collisions of the vehicle. Airbags are attached to one or more sensors in the vehicle which detect rapid vehicle deceleration. Upon identifying a rapid vehicle deceleration, the sensor signals the airbags to deploy. Common airbags rapidly inflate from a normally stowed/deflated condition, to a fully inflated condition, and deflate quickly thereafter. The airbag is designed to absorb the impact between the vehicle occupant and vehicle structure. An example includes airbag systems mounted within a steering column/steering wheel or a dashboard section which deploy to protect occupants during forward/rear impacts.

Airbag systems mounted to permanent, overhead roof structure, e.g., side airbags, generally open during side impacts. A disadvantage of side airbag systems is that permanent structure required to mount or stow the airbag(s) is generally not available on vehicles having convertible roofs, retractable hardtop roofs or removable hardtop roofs. A further disadvantage of these systems is that structure to orient the deployment direction of an airbag system may not be available.

Airbag systems mounted to permanent, overhead roof structure, are known. An example of such an airbag system is U.S. Pat. No. 5,470,103, to Vaillancourt et al., issued Nov. 28, 1995, assigned to Davidson Textron Inc. An example of an airbag system mounted to a headliner of a vehicle is U.S. Patent Publication U.S. 2002/0190506 A1, to Tiesler, Dec. 19, 2002. The subject matter of the above U.S. patent and patent publication are incorporated herein by reference. A disadvantage of these overhead ceiling or headliner mounted airbag systems is that the permanent structure in both a forward/rear and side-to-side direction required to mount or actuate the airbag(s) is generally not available on vehicles having convertible roofs, retractable hardtop roofs or removable hardtop roofs.

Convertible automobiles generally have several interconnected rails on each side of the vehicle to support the convertible roof and allow for roof motion. An example of an outfolding side rail locking design for a convertible automobile application is provided in U.S. Serial number (Not Yet Assigned), entitled “Joint Locking Device for a Convertible Roof System”, invented by A. MacNee et al. (attorney docket no. 5362-000464), filed on the same day with the present application. The subject matter of this application is incorporated herein by reference.

According to one embodiment of the invention, an automobile vehicle displaceable roof includes a pair of vehicle roof support members, each having at least one side rail. A connecting structure joins the roof support members. The roof support members and the connecting structure operably form a vehicle displaceable roof. An automatically releasable airbag is connected to at least one of the side rails of the roof support members.

In another embodiment of the invention, an automobile roof-attached airbag system includes a pair of side rails having at least one airbag attached to each of the side rails. A sensor is detachably connectable to each airbag which initiates airbag deployment.

In still another embodiment of the invention, an airbag equipped vehicle roof system includes connectable structural members. A plurality of brackets each connect an airbag to one of the structural members. A pair of flexible weather-stripping members are also attached to the structural members, which are used to connect a vehicle top cover.

In yet still another embodiment of the invention, a method for constructing a vehicle movable roof is provided, the roof having tubular side members and a plurality of cross support members. The method includes: movably linking distal ends of at least two of the tubular members to form a topstack side rail; parallel aligning a pair of the topstack side rails; linking the parallel aligned topstack side rails with the cross support members to form a retractable roof structure; attaching an airbag to a vehicle inside facing surface of each of the tubular members; and covering the retractable roof structure with a vehicle roof.

The present invention provides several advantages. By locating one or more airbags in the support rails, removable roof systems such as sliding panels, hard covers, or retractable hard top covers have improved vehicle passenger safety. Rail geometry is configured to direct airbag deployment substantially downward and inward and adjacent to vehicle occupants. A removable and/or a plug-in joint between airbag wiring and the sensor allows entire installation/removal of the roof system while retaining the sensor within the vehicle structure.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a fragmentary perspective view of a vehicle having a displaceable roof airbag system of the present invention extendable from a vehicle convertible roof structure;

FIG. 2 is a side elevational view of a support rail structure supporting a displaceable airbag system of the present invention;

FIG. 3 is a cross sectional view, taken along line 3-3 of FIG. 2, of a rail having an airbag installed according to a first embodiment of the present invention;

FIG. 4 is a cross-sectional view, similar to FIG. 3, through a rail system of a second embodiment of the present invention;

FIG. 5 is a side elevational view of a two-member rail system supporting a retractable hard top airbag system according to a third embodiment of the present invention;

FIG. 6 is a cross-sectional view, taken along line 6-6 of FIG. 5, of a weather-stripping support and airbag for a rigid or semi rigid roof cover of the present invention;

FIG. 7 is a cross-sectional view, similar to FIG. 4, showing a fourth embodiment of the present invention for a multi-panel sliding roof airbag system of the present invention;

FIG. 8 is a side elevational view of a removeable hard top airbag system according to a fifth embodiment of the present invention;

FIG. 9 is a cross-sectional view taken at line 9-9 of FIG. 8 showing an airbag installed between a garnish and a rail of the fifth embodiment of the present invention; and

FIG. 10 is a fragmentary plan view of an exemplary wiring circuit for a displaceable roof airbag system of the present invention.

### DETAILED DESCRIPTION OF THE SEVERAL PREFERRED EMBODIMENTS

The following description of the several preferred embodiments is merely exemplary in nature and is in no way intended to limit the invention, its application, or uses.

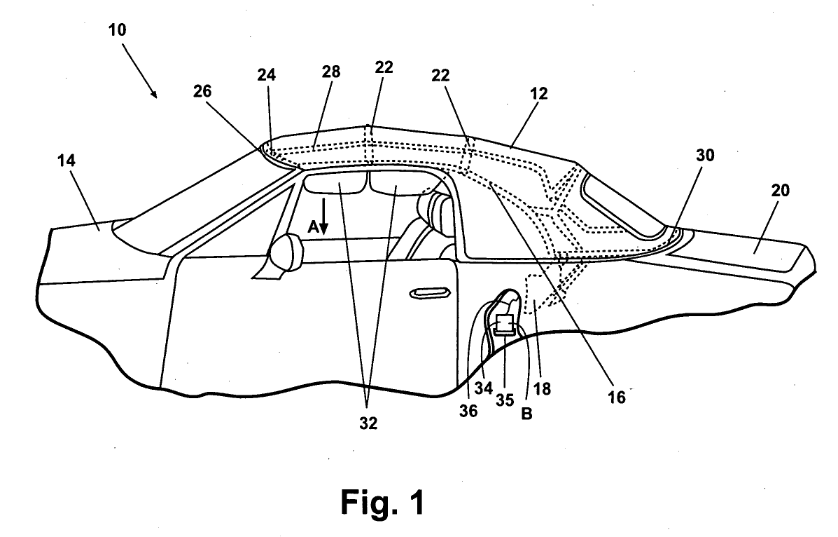

Referring to FIG. 1 and according to a first preferred embodiment of the present invention, a displaceable roof airbag system 10 of the present invention includes a convertible roof 12 attached to an automobile vehicle 14 using a roof support structure 16. Roof support structure 16 is attached to automobile vehicle 14 by an attachment structure 18. Convertible roof 12 is displaceable between a stowed position (not shown) located substantially in or forward of a trunk area 20 of automobile vehicle 14, and a fully extended position shown in FIG. 1.

Convertible roof 12 is supported in multiple locations by a plurality of roof bows 22. Roof bows 22 extend generally in a cross car orientation and are supported at distal ends to roof support structure 16. A number one bow 24 is latched to a windshield structure 26 to position convertible roof 12 in the fully deployed position shown. Portions of roof support structure 16 spanning fore and aft between roof bows 22 form a plurality of support rail structures 28, hereinafter referred to as “rails”. A weather-stripping 30 is provided at an outer perimeter of convertible roof 12 to provide a moisture seal at the junction between automobile vehicle 14 and convertible roof 12.

One or more inflatable assemblies, hereinafter referred to as airbags 32 (shown in a deployed position) are normally stowed in or on selected ones of the rails 28. Each airbag 32 inflates in a generally vehicle inward and downward facing direction “A”, to position the inflated airbag 32 adjacent a vehicle occupant (not shown). Each of the airbags 32 receive a signal to deploy from a sensor 34 supported by a structure 35 of automobile vehicle 14. Sensor 34 operates from a vehicle power source (not shown) such as a 12 Volt DC system and identifies a rapid vehicle deceleration condition. A sensor signal “B” is generated which initiates a deployment of the airbags 32. Sensor wiring 36 connects sensor 34 and each of the airbags 32 to operably transfer sensor signal “B” to airbags 32. Airbags 32 are commonly provided with an energy device (not shown) which is triggered by sensor signal “B” to inflate the airbags 32.

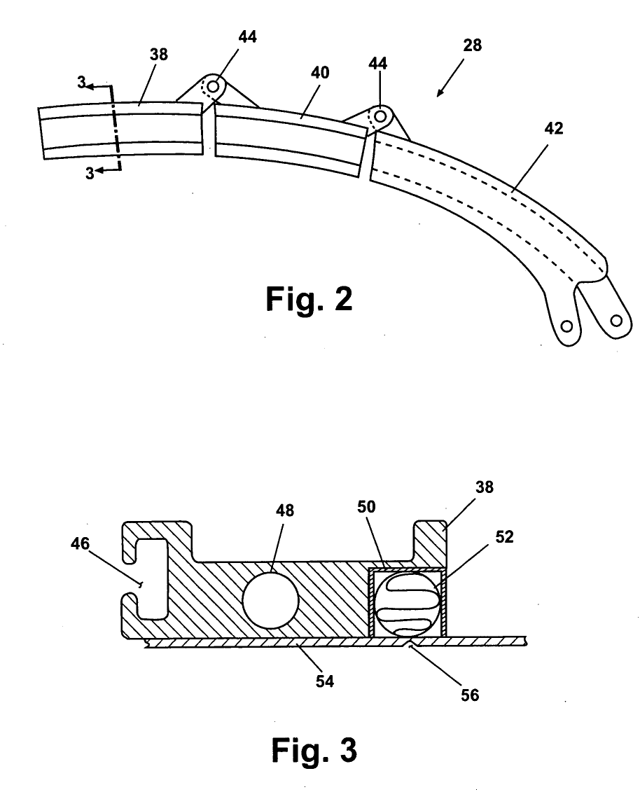

As seen in FIG. 2, rail 28 in a first preferred embodiment of the present invention has three rail segments including a front rail 38, a center rail 40, and a rear rail 42, respectively. Adjacent rail segments are pivotally connected to each other via a pivoting joint 44. Each of the pivoting joints 44 permit rail structure 28 to fold between a stowed position and the fully deployed position shown in FIG. 1. Actuators (not shown) such as electric or hydraulic motors are used to deploy convertible roof 12 and rail structure 28 between the stowed position and the fully deployed positions. Multiple rail segments connected by roof bows, together with one or more actuators form a top stack assembly. Such a top stack assembly is disclosed in U.S. Pat. No. 5,998,948, entitled “Convertible Roof Actuation Mechanism” which issued to Piontek et al. on Jun. 27, 1995, and is assigned to the assignee of the present invention, the disclosure of which is incorporated herein by reference.

As shown in FIG. 3, a section through front rail 38 identifies a weather-stripping retainer 46, a support core 48, and an airbag support 50. Weather-stripping retainer 46 is provided to support weather-stripping 30 identified in reference to FIG. 1. Support core 48 is provided as a circular rod, a section of pipe, or as any geometric shape commonly available in extruded or other form such as a rectangle, an oval, an I-beam, etc., and is preferably a metal material, however alternate materials, including polymeric materials and composite materials providing rigidity to front rail 38 can be used. The material for front rail 38 as well as the other rail sections, center rail 40 and rear rail 42, is preferably provided of a polymeric material. Support core 48 therefore provides additional stiffness in each rail. Support core 48 can be eliminated if the rail material is metallic, such as aluminum or steel.

Airbag support 50 provides a support and enclosure for a stowed airbag 52. The shape of airbag support 50 is shown as a generally rectangular shape, however any structural shape providing rigidity against the forces of deployment of the airbag 52 can be used. Airbag support 50 is generally open on a lower or interior vehicle facing surface of front rail 38. A garnish 54, preferably provided of a polymeric material, is provided on a substantially lower surface of front rail 38. Garnish 54 acts in part to hide front rail 38 as well as center rail 40 or rear rail 42 when applied thereto from occupants inside of vehicle 14. Garnish 54 can optionally be provided with a deformation 56 as necessary to allow deployment of stowed airbag 52 from the stowed position shown to the deployed position shown in FIG. 1.

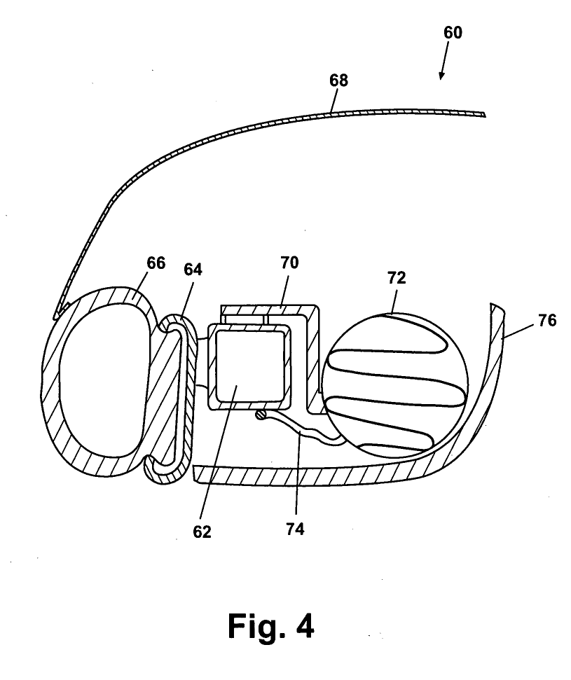

As best seen in FIG. 4, in a second embodiment of the present invention, a displaceable roof airbag system 60 includes a rectangular shaped rail 62. A C-shaped weather-stripping retainer 64 is connectably attached to rectangular shaped rail 62 and acts to support a flexible weather stripping 66. An automobile removable roof 68 abuts weather-stripping 66. A bracket 70 is located on a generally inward facing side of rectangular shaped rail 62 and attached to rectangular shaped rail 62 on a first end thereof. On a second end of bracket 70 an airbag 72 is supported. Airbag 72 receives its deployment signal via wiring 74. Wiring 74 is a continuation of sensor wiring 36 shown and described in reference to FIG. 1. Similar to the embodiment shown in FIG. 3, a garnish 76 is provided on a generally vehicle inward facing side of displaceable roof airbag system 60. Garnish 76 performs the same function as garnish 54 shown and described in reference to FIG. 3.

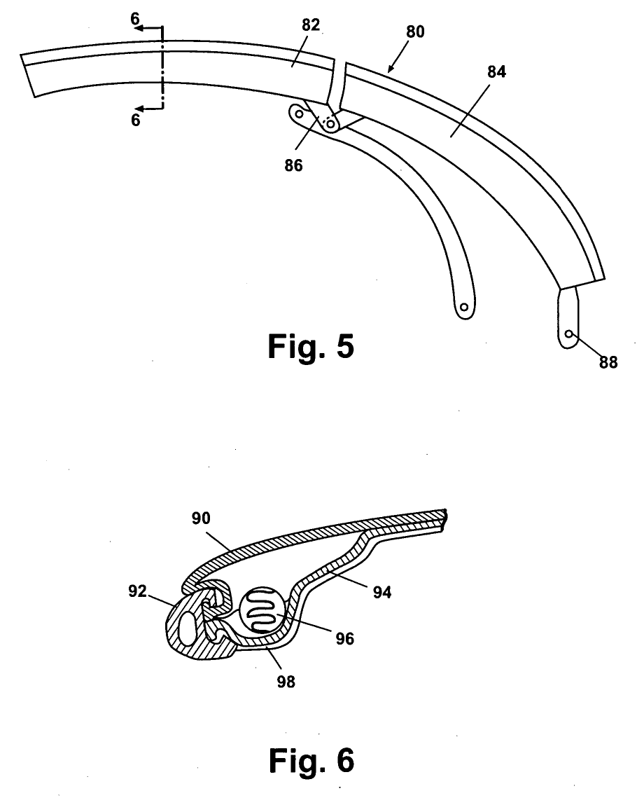

As seen in FIG. 5, a third embodiment of the present invention includes a retractable hard top airbag system 80. In the exemplary embodiment shown, retractable hard top air bag system 80 includes a two-part rail system having a first rail 82 and a second rail 84. First rail 82 is rotatably connected to second rail 84 using a rail pivot joint 86. Both first rail 82 and second rail 84 are pivotable about a roof pivot axis 88 to permit retractable hard top airbag system 80 to rotate between a stowed and a deployed position. FIG. 5 depicts the fully deployed position. In addition to the two-part rail system described, the invention applies to three-part or greater rail systems.

As seen in FIG. 6, a rigid or semi-rigid roof cover 90 abuts a weather-stripping 92. A polymeric liner 94 is provided on a vehicle inward or compartment facing side of roof cover 90. An airbag 96 is located within polymeric liner 94 and supported by polymeric liner 94. In this embodiment, a liner 98 (such as a cloth liner) is positioned on a vehicle inward facing side of polymeric liner 94 in place of polymeric garnishes shown and described in reference to the two previous embodiments. When actuated, airbag 96 perforates both polymeric liner 94 and liner 98 to deploy into the vehicle compartment. Roof cover 90 can be a metallic material, a polymeric material or a composite material.

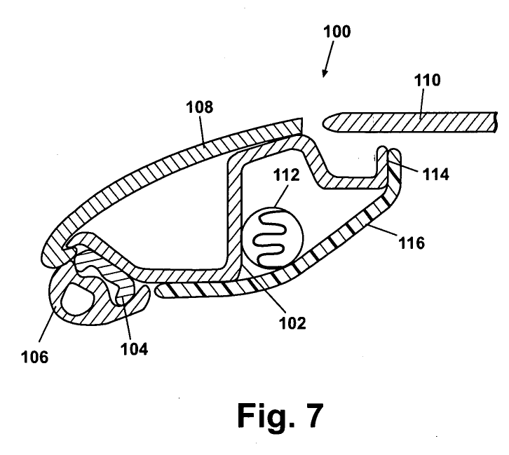

As best seen in FIG. 7, a fourth embodiment of the present invention includes a sliding roof airbag system 100. Sliding roof airbag system 100 includes an inner reinforcing rail 102. A weather-stripping retainer 104 is connectably attached to inner reinforcing rail 102. A weather-stripping 106 is supported by weather-stripping retainer 104. A roof edge 108 is supported by inner reinforcing rail 102. A sliding roof panel 110 slidably engages with sliding roof airbag system 100 at a junction with roof edge 108. A motion of sliding roof panel 110 is into or out of the page as viewed in FIG. 7. Sliding roof airbag system 100 includes an airbag 112 supported by inner reinforcing rail 102. Airbag 112 can deploy in any position of sliding roof panel 110. A rain gutter 114 is located adjacent to the inner section between sliding roof panel 110 and roof edge 108. Airbag 112 deploys through a garnish 116 positioned on an interior compartment facing side of inner reinforcing rail 102. Garnish 116 is preferably a polymeric material having a perforation or structurally weakened area through which airbag 112 deploys. A cloth interior liner can also be provided on the interior compartment facing side of inner reinforcing rail 102 in place of garnish 116.

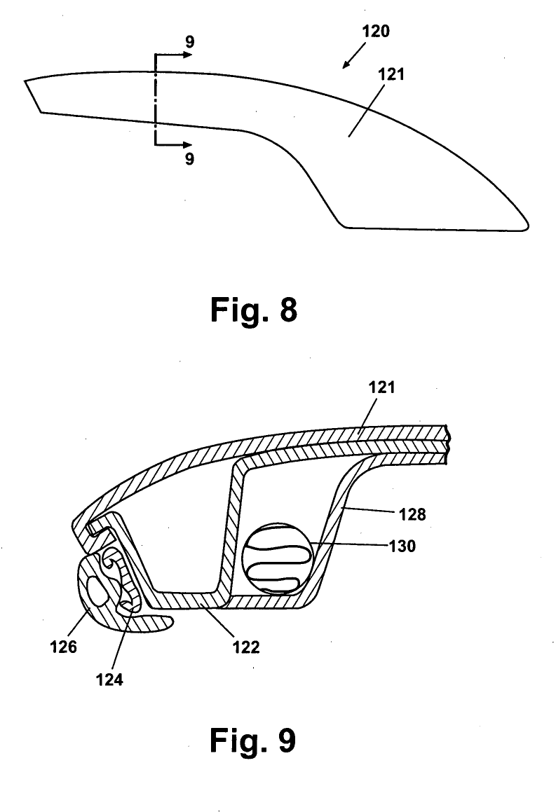

As seen in reference to FIGS. 8 and 9, in still another embodiment of the present invention, a removable hard top airbag system 120 includes a vehicle hard top 121. Vehicle hard top 121 is supported on each side by a rail 122. A weather-stripping retainer 124 is connectably attached to each rail 122 and supports a flexible weather-stripping 126. A garnish 128 is supported from an interior facing side of rail 122. Garnish 128 supports an airbag 130. Airbag 130 in the manner previously described deploys through garnish 128. Vehicle hard top 121, with rail(s) 122 is removable as a single unit from a vehicle (not shown). Vehicle hard top 121 is fully deployed when it is latched to the vehicle.

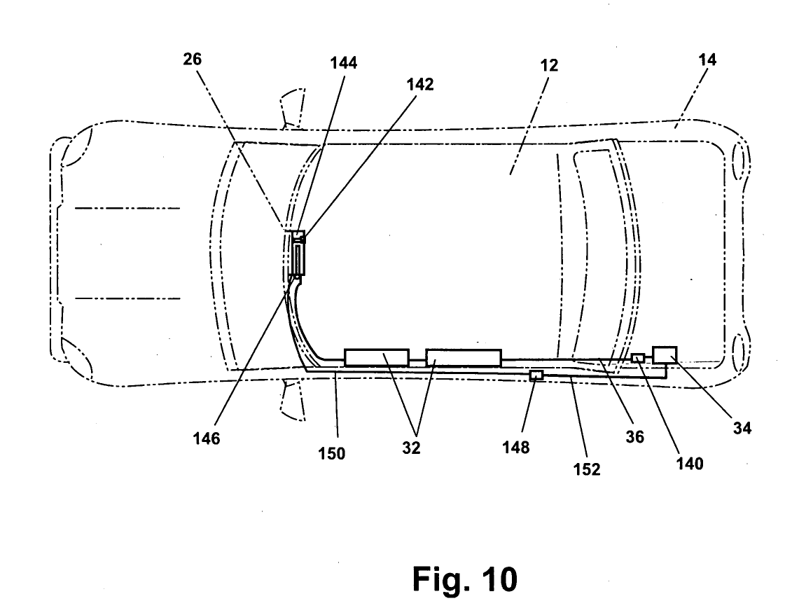

Referring to FIG. 10, an exemplary circuit is shown providing feedback to sensor 34 to identify that convertible roof 12 is in a fully latched position, which enables sensor 34. A plug 140 is provided in sensor wiring 36 between airbag 32 and sensor 34. Plug 140 provides the capability to completely remove convertible roof 12 (or a similar removable roof system) by disconnecting sensor wiring 36 via plug 140. When convertible roof 12 is in the deployed position, one or more latch bolts (not shown) engage a latch 144 positioned adjacent windshield structure 26 (shown in FIG. 1). Convertible roof 12 can also be provided with a connector pin 146 which completes a circuit between sensor wiring 36 and latch 144, via wiring 150. In another embodiment, sensor 34 is deactivated and unable to signal airbags 32 to deploy unless a logic circuit 148, acting as a switch within a circuit complete wiring 152, completes an electrical power path to sensor 34. The wiring system of FIG. 10 can be used for any displaceable roof airbag system of the present invention to prevent airbag deployment when rail structure supporting the one or more airbags is not positioned for proper deployment of the airbags.

Displaceable roof airbag systems according to the present invention provide several advantages. By locating one or more airbags in the support rails for retractable or removable roof systems of vehicles, vehicles having soft top convertible roofs, removable roofs such as sliding panels and/or hard covers, and retractable hard top covers are provided with airbags for deployment toward vehicle passengers. By configuring the geometry of the rails that support the airbags, the airbags are directed to deploy in a substantially vehicle downward and inward direction and adjacent to vehicle occupants. At least one sensor connected through a sensor wiring system is used to actuate the airbags of the present invention. A removable joint, for example a plug-in joint, is located between the wiring to the airbags and the sensor such that a removable roof system (for example a hard top removable roof system) can be installed and/or removed in its entirety while retaining the sensor in a supported position within the vehicle structure.

The description of the invention is merely exemplary in nature and, thus, variations that do not depart from the gist of the invention are intended to be within the scope of the invention. Such variations are not to be regarded as a departure from the spirit and scope of the invention.

1. An automobile vehicle displaceable roof, comprising:
a vehicle displaceable roof structure; and
an inflatable protective assembly coupled to the displaceable roof structure.

2. The roof of claim 1, comprising:
a plurality of vehicle roof support members including at least two side rails having a forward most side rail longitudinally alignable and rotatably connectable to an adjacent side rail; and
an inter-connecting structure operably joining the roof support members and defining with the roof support members part of the displaceable roof structure.

3. The roof of claim 2, comprising:
an external surface of each side rail;
wherein the inflatable protective assembly is mounted to the external surface of at least one of the side rails.

4. The roof of claim 2, comprising:
an internal cavity operably formed in each of the side rails;
wherein the inflatable protective assembly includes a plurality of airbags each mounted within the internal cavity of one of the side rails.

5. The roof of claim 2, wherein the inter-connecting structure further comprises at least one roof bow coupled to parallel ones of the roof support members.

6. The roof of claim 1, comprising a vehicle soft cover supportable by the displaceable roof structure.

7. The roof of claim 1, comprising a vehicle hard cover supportable by the displaceable roof structure.

8. The roof of claim 1, comprising:
a fully deployed position of the displaceable roof structure; and
a sensor operable to send a deployment signal to the inflatable protective assembly, the sensor operable only in the fully deployed position of the displaceable roof structure.

9. An automobile roof-attached airbag system, comprising:
a displaceable vehicle roof structure;
at least one airbag fixedly attached to the displaceable vehicle roof structure; and
a sensor connectable to the at least one airbag and operable to initiate an airbag deployment.

10. The airbag system of claim 9, wherein the displaceable vehicle roof structure comprises:
a plurality of structural members;
at least a pair of the structural members connectable to define a vehicle side rail; and
an opposed pair of the side rails connectably joined to form the displaceable vehicle roof structure;
wherein the at least one airbag is fixedly attached to at least one of the side rails.

11. The airbag system of claim 9, comprising a detachable connection operably joining the sensor and the at least one airbag.

12. The airbag system of claim 11, comprising:
a structural support operably supporting the sensor, the structural support remotely positionable from the displaceable vehicle roof structure;
wherein the detachable connection is operable to detach the sensor from the at least one air bag.

13. The airbag system of claim 10, wherein the at least one airbag comprises a plurality of airbags each mountable to one of the side rails.

14. The airbag system of claim 13, comprising:
an airbag support member operatively supporting a select airbag to one of the side rails;
wherein the airbag support member operably orients a deployment direction of the select airbag.

15. The airbag system of claim 9, comprising:
a fully deployed position of the displaceable vehicle roof structure; and
a switch operably closed only in the fully deployed position;
wherein the sensor is inoperable to initiate the airbag deployment until the switch is operably closed.

16. The airbag system of claim 10, comprising a first rotatable joint connectably joining each pair of the structural members of each side rail.

17. The airbag system of claim 16, wherein the displaceable vehicle roof structure comprises a plurality of second rotatable joints permitting rotation of the roof structure between a fully deployed position of the vehicle roof structure and a stowed position of the vehicle roof structure.

18. The airbag system of claim 10, comprising a rigid joint operably joining each pair of the structural members.

19. An airbag equipped vehicle roof system, the system comprising:
a plurality of structural members each having an inside face and an outside face;
a displaceable vehicle roof structure having opposed member groups, each member group including at least two connected ones of the structural members;
at least one airbag mounted to the displaceable vehicle roof structure; and
a vehicle top cover operably joined to at least the weather-stripping members.

20. The roof system of claim 19, comprising a fully deployed position of the vehicle roof structure wherein each airbag is configurable to deploy in a substantially inward and downward direction.

21. The roof system of claim 19, further comprising a sensor connectable to each of the airbags operable to energize deployment of the airbags.

22. The roof system of claim 19, further comprising a pair of flexible weather-stripping members each connectably attached to one of the opposed member groups.

23. The roof system of claim 22, further comprising an interior trim garnish connectable to one of the weather-stripping members and at least partially enclosing the airbag and one of the member groups.

24. The roof system of claim 23, further comprising a deformation in the interior trim garnish operably perforated upon deployment of the airbag.

25. The roof system of claim 19, comprising a pivot mechanism rotatably connecting longitudinally adjacent ones of the structural members.

26. The roof system of claim 19, wherein the vehicle top cover comprises a pliable material.

27. The roof system of claim 19, wherein the vehicle top cover comprises a substantially rigid material.

28. The roof system of claim 19, comprising a plurality of brackets each having a first end joined to the inside face of one of the structural members and a second end, wherein each airbag is connectable to the second end of one of the brackets.

29. A method for constructing a displaceable vehicle roof having side members, the method comprising the steps of:
coupling together distal ends of at least two of the side members to operably form a side rail;
aligning a pair of the side rails;
linking the pair of side rails to operably form a retractable roof structure; and
attaching an airbag assembly to at least one of the side members.

30. The method of claim 29, comprising attaching a pliable fabric material to the retractable roof structure.

31. The method of claim 29, comprising attaching at least one solid roof member to the retractable roof structure.

32. The method of claim 29, comprising orienting the airbag assembly to deploy in a substantially vehicle inward and downward facing direction.

33. The method of claim 29, comprising interconnecting the airbag assembly with a deployment sensor.

34. The method of claim 33, comprising installing a disconnect joint between the deployment sensor and the retractable roof structure operable to permit removal of the retractable roof structure.

35. The method of claim 29, comprising producing the side members having a substantially rectangular shape and a hollow tubular form.

36. The method of claim 29, comprising:
at least partially covering the side members and the airbag assembly with an interior garnish;
creating a weakened section in the interior garnish; and
deploying the airbag assembly through the weakened section.

37. The method of claim 29, comprising:
forming a weather-stripping border on an exterior facing side of the side members; and
mating the vehicle roof with the weather-stripping border.
